(19) United States
(12) Patent Application Publication
(10) Pub. No.: US 2016/0131163 A1
(43) Pub. Date: May 12, 2016

(54) Hydrostatic Drive For Variable Speed Operation of Rotational Equipment

(71) Applicants: Robert Tolbert, Wilsonville, AL (US); Benjamin Tolbert, Wilsonville, AL (US); Joshua Tolbert, Wilsonville, AL (US)

(72) Inventors: Robert Tolbert, Wilsonville, AL (US); Benjamin Tolbert, Wilsonville, AL (US); Joshua Tolbert, Wilsonville, AL (US)

(21) Appl. No.: 14/881,750

(22) Filed: Oct. 13, 2015

Related U.S. Application Data
(60) Provisional application No. 62/122,179, filed on Oct. 14, 2014.

(51) Int. Cl. F15B 13/02; F15B 13/08; F15B 1/26; F15B 11/17

(52) U.S. Cl. CPC F15B 13/027; F15B 11/17; F15B 13/0803; F15B 1/26; F15B 2211/20507; F15B 2211/20546; F15B 2211/20538; F15B 2211/20576; F15B 2211/255; F15B 2211/27; F15B 2211/7107; F15B 2201/405; F15B 2201/411

(57) ABSTRACT

A hydrostatic drive, to operate rotational industrial equipment such as a fan, a pump, a compressor, a conveyor or other drive used in industrial settings. The invention utilizes one or more variable displacement pump(s) configured to drive one or more fixed displacement hydraulic motor(s), or utilizing one or more fixed displacement pump(s) configured to drive one or more variable displacement hydraulic motor(s) or utilizing one or more variable displacement pump(s) configured to drive one or more variable displacement hydraulic motor(s). The pump(s) is powered by a fixed speed or variable speed motor or engine, most likely a fixed speed electric motor. The motor operates the rotational equipment with the purpose of process control, efficiency, and/or energy conservation.

This application relates to U.S. provisional patent application No. 62/122,179 filed on Oct. 14, 2014.

### BACKGROUND OF THE INVENTION

### Field of the Invention

Hydraulics, hydrostatic drives, equipment drives, and process control.

This invention relates to industrial applications needing to drive industrial rotational motors such as fan motors to move air for various industrial reasons. Industrial buildings need to move air from outside to inside, from inside to outside, and within the structure. Environmental reasons may make existing applications unsuitable or less cost efficient than the present invention. Previously, industry has found it necessary to vary the output of fans, compressors, pumps, conveyors and other rotating equipment for control, process or operational cost. Whether the motivation be variable process or reduced power consumption, the need for variable output equipment exists. Variable output equipment has been accomplished in a variety of methods. The most rudimentary method is with some additional piece of control equipment such as a control valve, damper, gate or similar. Over time, it became apparent that varying the speed of the equipment was a superior method as this method reduces equipment load and power consumption. These speed changes have been accomplished in many different ways. For use with fixed speed prime movers, many variable drive systems have been used such as gear drives, belt drives, friction drives and other varying types of devices. These devices accomplished the goal of changing one drive speed to another, but did not provide a sufficient process for varying the speed for variable process control and energy efficiency.

In order to provide methods of variable process control, technology has been developed to meet industry needs of variable speed equipment. The most basic form of variable equipment speed operation is by use of inherently variable speed prime movers such as engines and turbines. However, this form of variable speed equipment precluded use of the most convenient and most desired prime mover—the electric motor. Creative ideas were tried over the history of industrial operations and products were produced in attempt to accommodate the electric motor. Variable speed motors using primitive designs were utilized. Variable resistance devices to reduce current and/or voltage were employed. Variable speed belt sheaves and belts were used. Later Variable Frequency Drives (hereinafter VFD) were used, and found to be highly advantageous in some respects. They provided soft starts, allowed infinite variance of electric motor speeds and were electrically efficient. VFDs, however, were not desirable in some aspects. They were not tolerant of high temperature ambient conditions, dust, grit, rain and other adverse environment, many times requiring them to be housed in climate controlled rooms. VFDs are also known to create maintenance issues associated with electronic harmonics and reduce electric motor life in addition to often requiring inverter duty motors. Further, VFD service or maintenance almost always required a factory service technician to perform these services, via a costly on-site service. Due to additional costs such as controlled climate rooms, the ongoing cost of climate control, air filtration, maintenance issues, compatibility with existing motors and other issues, many of the requirements for VFDs, particularly medium and high voltage VFDs, limit VFDs use in industry due to cost considerations.

Some unique devices have been developed that resolve the issues associated with VFDs, and provide a variable connection between the electric motor and the equipment. Some of these include magnetic drives, variable belt drives, fluid couplings and other. However, many of these exhibit lesser mechanical efficiency in comparison to a VFD and have associated maintenance and cost issues of their own. The concept of a hydrostatic drive, or hydraulic variable drive, provides many different advantages over a VFD and these other forms of variable connection devices. First, a hydrostatic drive does not require a climate controlled room, provided ambient temperatures are not extreme. A hydrostatic drive can tolerate a dusty or dirty environment with periodic cleaning. A hydrostatic drive is easily serviced by maintenance personnel who are familiar with hydraulics and hydraulic principles. Parts for hydrostatic drives, such as pumps, motors, hoses, filters, coolers, reservoirs, etc., are commonly available. A hydrostatic drive is based on known, reliable hydraulic principles. Hydrostatic drives are easily controlled, manually or automatically, to provide virtually any operating speed from nearly stationary to full speed, without adverse effects to the drive or motor. The controls can be automated to provide ongoing process control. Additionally, hydrostatic drives may function as a brake and may operate in reverse direction while maintaining electric motor speed and direction. Furthermore, hydrostatic drives are highly efficient in comparison to most variable connection devices and allow flexible configurations of equipment and prime mover such as orientation and location. Hydrostatic drives can utilize any number of prime movers driving any amount of machinery on a single system. For these reasons, a hydrostatic drive is a highly desirable solution to drive variable speed equipment in many industrial and commercial applications. Prior Art has several devices that relate to this field; the present invention is an improvement on them and applies them to the operation of industrial fans and similar systems.

U.S. Pat. No. 8,714,116 B2, Hartman, teaches a fan cooling system and method to control fan speed for cooling motor vehicle motor components while minimizing power consumption by the fan and reducing engine fuel consumption for an engine partially powering the fan. The fan cooling system raises engine coolant temperature of a vehicle in motion to derive a fan speed demand so that fan speed may be reduced. The fan cooling system selects a maximum fan speed demand from one or more fan speed demands to command fan speed based on various sensed inputs, including engine coolant temperatures.

U.S. Pat. No. 5,875,630, Walsh, teaches a hydraulic drive assembly for engine driven vehicles which includes a variable displacement pump fluidly connected in a closed loop circuit with a motor for driving an ancillary device, such as a fan. An auxiliary pump can be operatively connected to the pump, the motor and a reservoir for replenishing fluid losses in the closed loop circuit. An auxiliary circuit connected to the pump has a recirculating passage fluidly connected to the closed loop circuit downstream of the motor to reduce the necessary reservoir volume. A method for smoothly and continuously adjusting the output of the pump to drive the ancillary device is also disclosed. overdrive the fan for cooling. This invention is characterized by a high outlay in terms of the adjustment of the variable displacement pump is required and the fan can be actuated in only one direction.

U.S. Patent Application 20120304636 A1, Nelson, teaches a hydraulic fan circuit for heavy equipment cooling fans which includes a primary pump, a motor fluidly connected to the primary pump, and a fan operably connected to and driven by the motor. The circuit also includes a supply passage extending from the primary pump to the motor, a return passage extending from the motor to the primary pump, and a pressure limiting valve configured to selectively reduce pressure of a flow of pilot fluid directed to the primary pump. The circuit further includes an override valve configured to selectively connect the supply passage to the pressure limiting valve.

U. S. Patent Application 20120060777 A1, Tikkanen, teaches a hydrostatic fan drive for internal combustion engines on mobile equipment or vehicles, having a primary unit that can be driven by the internal combustion engine, and having a fan motor by means of which a blower fan can be driven. A hydraulic reservoir is disposed at a high-pressure line connecting the primary unit to the fan motor. A hybrid fan drive for internal combustion engines is thus provided, allowing fan operation even if the internal combustion engine is switched off. An increased maximal available power of the internal combustion engine is available in transition, despite the fan operation, because the fan motor can be supplied with pressurized media by the hydraulic reservoir in such cases (in transmissions).

U.S. Pat. No. 3,978,937, Chichester, teaches a closed circuit hydrostatic recirculating transmission system for driving a traction vehicle with an internal combustion engine. The primary unit that is be driven by the internal combustion engine, and a transmission for propelling the vehicle is included.

U.S. Pat. No. 6,179,570 B1, Smith, teaches a fan drive in which the adjustment of the variable displacement pump toward a reduction in the feed volume can be adjusted via an electro proportionally adjustable pressure regulating valve (DRE), the control oil being picked off from the pressure medium volume flow to the hydraulic motor. This invention is characterized by only one direction of rotation of the hydraulic motor and the internal control oil pick-off is subject to comparatively high fluctuations.

U.S. Pat. No. 6,684,636 B2, Smith, teaches a hydrostatic drive with a variable displacement pump which is pivotable through zero and drives a hydraulic motor, the drive torque of which is reversible. The variable displacement pump is adjusted via an actuating cylinder which is prestressed toward the minimum feed volume flow. The actuating cylinder is adjusted toward a higher feed volume flow via an electroproportionally adjustable pressure regulating valve with external control oil supply. If, then, the hydraulic motor is used for driving a fan, in the event of a power failure in the control electronics, the variable displacement pump pivots back to zero, and therefore, correspondingly, the fan is no longer driven, and then overheating of the coolant and consequently engine damage may occur.

U.S. Pat. No. 8,707,691 B2, Loritz, teaches a hydrostatic drive, in particular a fan drive, with a variable displacement pump is configured to drive at least one hydraulic motor. The variable displacement pump is activated via a pressure regulating valve and a following directional valve predetermining the feed direction, via which valves the control spaces of an actuating cylinder can be acted upon with a control pressure difference. The variable displacement pump is prestressed into a basic position in which the feed volume flow is at a maximum.

U. S. Patent Application 20120020811 A1, Kraeutler, teaches a hydraulic fan control circuit for a motor vehicle, a construction machine, or a lifting device, with at least one hydraulic pump and at least one hydraulic motor for driving at least one fan, wherein the hydraulic motor driving torque of at least one hydraulic motor is controllable by adjusting the absorption volume.

U. S. Patent Application 20130318953 A1, Geissler, teaches a hydrostatic fan drive which includes a hydraulic constant-displacement pump configured to drive a hydraulic motor for a fan. The drive further includes a hydraulic machine configured to supply a second hydraulic circuit with a pressure medium. The constant-displacement pump is configured to be hydraulically combined with the hydraulic machine. This is characterized by the combination valve being a non-return valve which opens in the direction of flow to the second circuit and an adjustment device configured to set a displacement volume of the hydraulic machine is further configured to be adjusted as a function of the operating state in the first hydraulic circuit or as a function of a maximum load pressure of the consumers.

### SUMMARY OF THE INVENTION

The object of this invention is to provide process control by varying the speed of rotational driven industrial equipment through the use of hydraulics or hydrostatic drive. This provides industrial plants an effective alternative to Variable Frequency Drives (VFDs) and other variable speed drives, and/or flow control equipment (e.g. control valves, dampers, etc.) as a means of controlling process speeds on fans, pumps, compressors, conveyors and other industrial plant devices that often do not operate at optimum speeds, wasting energy and other resources.

The current invention is that of utilizing a hydrostatic drive to provide a method of variable operation of rotational machinery. By utilizing hydraulics, and specifically an energy efficient hydrostatic drive, plant maintenance personnel can easily troubleshoot and repair the components on-site, by simple hydraulic troubleshooting techniques. Further, with robust hydraulic design, the hydrostatic device is capable of operating in harsh ambient conditions and precludes the necessity of building controlled climate rooms.

Energy is at a premium, and the ability to conserve energy is crucial today and in the future, both from an economic and environmental impact. By utilizing hydrostatic drives or hydraulic variable drives (hereinafter HVDs), the end user now has a means to reduce both energy requirements and operating costs of driven machinery, even if constantly varying conditions exist. Affinity laws state centrifugal machinery power consumption is a cubic function of rotational speed. Therefore, it follows, by reducing machinery speed 50%, power consumption is reduced by 88%.

This device, or invention, uses existing hydraulic principles in a unique application to provide optimum energy usage, and/or minimize energy consumption. The technology, is a novel device to allow flexibility and optimal energy consumption in areas that were once cost prohibitive due to availability, application, environmental operating conditions or other reasons.

The system that is the subject of this disclosure conceptually uses a prime mover, a hydraulic pump, hydraulic lines, a control valve, a hydraulic motor, driven equipment, a filter, a cooler and a reservoir.

### BRIEF DESCRIPTION OF THE DRAWINGS

The following drawings are illustrative of embodiments of the invention and are not meant to limit the scope of the invention as encompassed by the claims.

FIG. 1 is a flow schematic of a closed loop embodiment of the Hydraulic Variable Drive utilizing a prime mover to operate a pump and a rotational motor to operate a piece of rotational machinery.

FIG. 2 is a flow schematic of an open loop embodiment of the Hydraulic Variable Drive utilizing a prime mover operating a pump and a rotating motor operating a piece of rotational machinery.

FIG. 3 is a flow schematic of a closed loop embodiment of the Hydraulic Variable Drive utilizing a prime mover to operate a pump and a plurality of motors to operate a plurality of rotational machinery.

FIG. 4 is a flow schematic of an open loop embodiment of the Hydraulic Variable Drive utilizing a prime mover operating a pump and a plurality of motors operating a plurality if rotational machinery.

FIG. 5 is a flow schematic of a closed loop embodiment of the Hydraulic Variable Drive utilizing a prime mover to operate a pump, a rotational motor to operate a piece of rotational machinery, and an auxiliary pump powered by an auxiliary prime mover to avoid system damage or to operate the system in the event of a sudden loss of power to the prime mover.

FIG. 6 is a flow schematic of an open loop embodiment of the Hydraulic Variable Drive utilizing a prime mover operating a pump, a rotating motor operating a piece of rotational machinery, and an auxiliary pump powered by an auxiliary prime mover to avoid system damage or to operate the system in the event of a sudden loss of power.

FIG. 7 is a flow schematic of a closed loop embodiment of the Hydraulic Variable Drive utilizing a plurality of prime movers operating a plurality of pumps and a motor operating a piece of rotational machinery.

FIG. 8 is a flow schematic of an open loop embodiment of the Hydraulic Variable Drive utilizing a plurality of prime movers operating a pump and a rotational motor operating a piece of rotational machinery.

### DESCRIPTION OF THE PREFERRED EMBODIMENTS

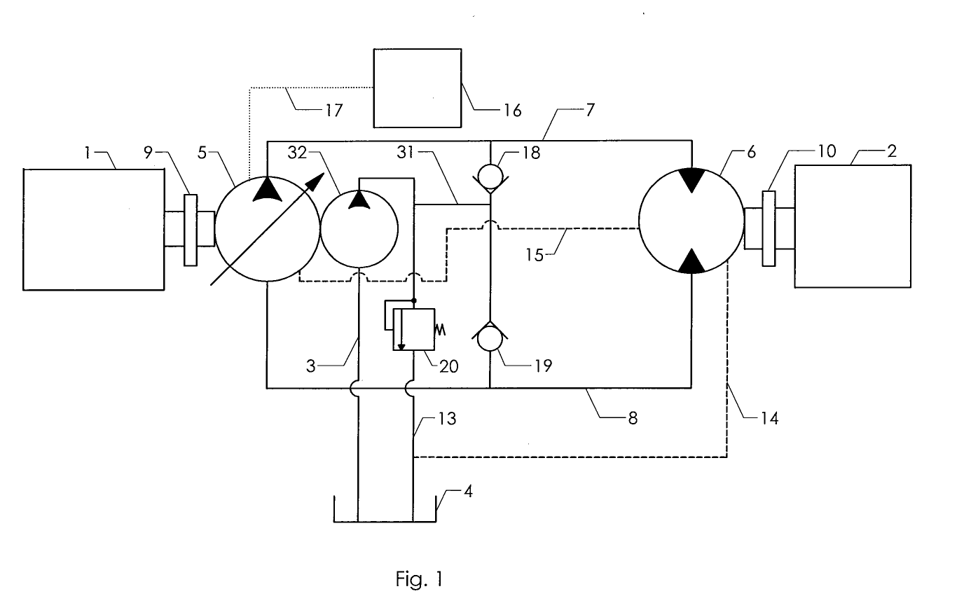

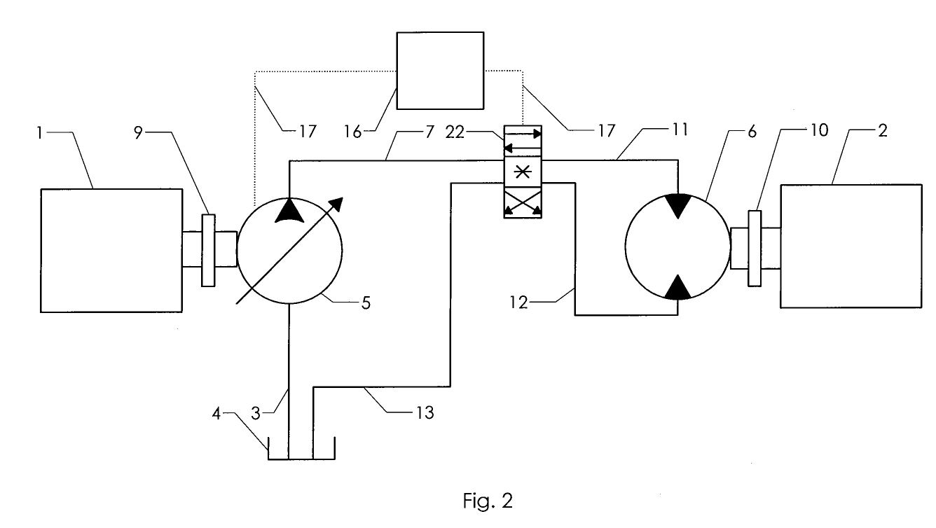

Referring to the drawings in detail, a detailed description of the preferred embodiments is given here. The primary functionality of this presented art is to provide a means to provide variable transmission of power from a prime mover 1 to some rotating machinery 2. FIGS. 1, 3, 5, and 7 illustrate various closed loop embodiments while FIGS. 2, 4, 6, and 8 illustrate various open loop embodiments.

Referring to FIG. 1 for a closed loop version, a hydraulic variable drive (HVD) is used to variably drive rotational machinery 2, which may include a fan, pump, compressor, conveyer, or crusher, from mechanical power provided by a prime mover 1 of any type such as engine, electric motor, turbine or other motor, whether fixed or variable speed. A pump 5, whether fixed or variable displacement, whether unidirectional or bidirectional, provides fluid to a motor 6, whether fixed or variable displacement, whether bidirectional or unidirectional. Motor 6 is mechanically connected to rotational machinery 2 by coupling 10. Any suitable means may be used including direct connection, coupling, gears, hydraulic pressure, pneumatic, or belts.

The prime mover 1 drives the pump via a mechanical connection 9. Fluid is pulled from a reservoir 4 by a charge pump 32 through suction line 3. The outlet charge pump line 31 transfers charge fluid from the charge pump 32 to either the A line 7 or the B line 8 depending on the flow direction of the pump 5 and pressure in the A line 7 and pressure in the B line 8, the flow passes through the A line check valve 18 or the B line check valve 19 such to be delivered to the corresponding line (which is the low pressure line).

Depending on the direction of flow through the pump 5 as controlled by external input 17, the A line 7 or the B line 8 could be the high pressure line, leaving the other to be the low pressure line. In this embodiment, it is defined that in the forward flow the A line 7 is the high pressure line in a forward direction and the B line 8 is the low pressure line, while in reverse flow the B line 8 is the high pressure line in a forward direction and the A line 7 is the low pressure line.

Fluid from the pump feed line 31, after passing through the appropriate check valve 18 or 19, is fed to the low pressure line according to the direction of flow as described. The fluid in the low pressure line 7 or 8 is drawn in by the pump 5 and discharged at a higher pressure in the high pressure line 7 or 8. The high pressure line 7 or 8 delivers the high pressure fluid to the hydraulically operated rotational motor 6, such to cause rotation.

If the A line 7 is the high pressure line, the motor 6 rotates in a clockwise direction. If the B line 8 is the high pressure line, the motor 6 rotates in a counter-clockwise direction. As the fluid passes through the motor, the fluid pressure is reduced and discharged in the low pressure line 7 or 8, depending on the flow direction. The outlet flow of the pump 5 may be varied by external input 17, resulting in a variable speed rotation of the rotating machinery 2. Additionally, due to description of operation, the outlet flow of the pump 5 may also be reversed by external input 17, thus reversing the direction of rotation of the motor 6, resulting in a reversal of rotating machinery 2 rotation direction. The external input 17 to the pump 5 is controlled by control 16.

Inherent to the pump 5 and motor 6, some fluid leaks internally in the equipment and is contained in the case of the equipment. A case drain 15 feeds the internal pump leakage from the pump 5 to the motor 6. This fluid, along with internal motor leakage is drained through a case drain 14. Alternatively, the pump case drain 15 could be routed to be delivered directly to the reservoir 4 without passing through the motor 6, if desired.

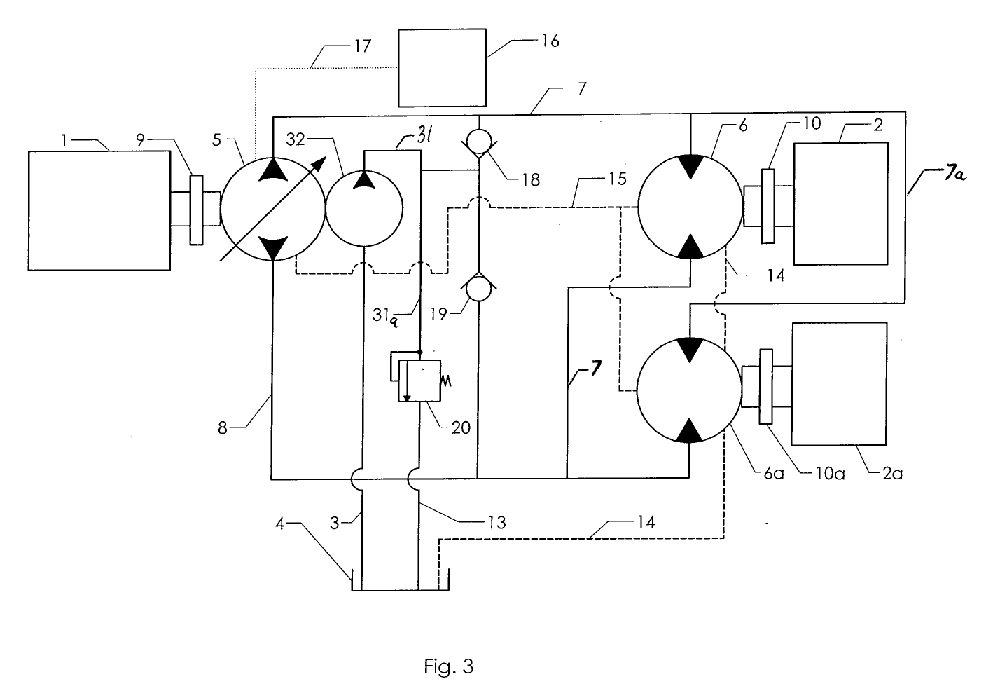

FIG. 3 illustrates a preferred closed loop embodiment very similar to that given in FIG. 1 with the exception that it utilizes a pump 5 and a plurality of motors 6 and 6a.

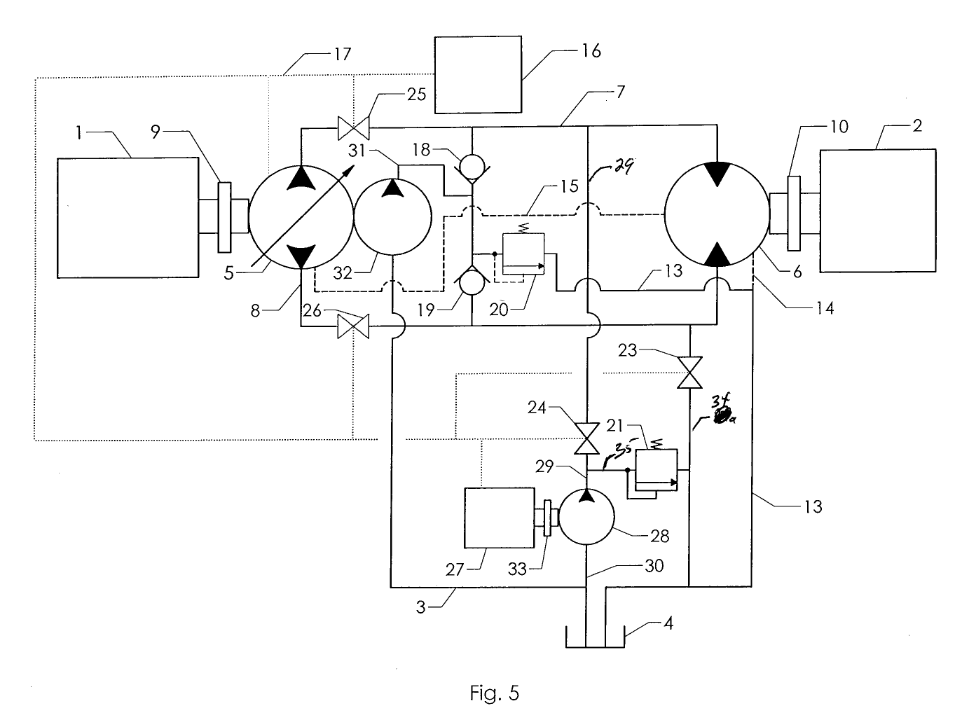

FIG. 5 illustrates a preferred closed loop embodiment very similar to that given in FIG. 1 with an auxiliary pump 28 powered by auxiliary prime mover 27. In the event of failure of prime mover 1, the auxiliary system activates. When activated, auxiliary prime mover 27 operates and is connected by coupling 33 to operate auxiliary pump 28 drawing fluid from reservoir 4 through line 30. Auxiliary pump discharge line 29 has remotely operated auxiliary pump supply line shut off valve 24 (normally closed) which opens when the auxiliary system is activated to allow the fluid to flow through line 29 into line 7. Fluid flows back to the reservoir tank 4 through line 34 when return shut off valve 23 opens which occurs when the auxiliary system is activated. When the auxiliary system is activated, remotely operated A line isolation shut off valve 25 and remotely operated line B isolation shut off valve 24 close. Also shown are relief valves 20 and 21 to provide a pressure relief in the event of over pressurization of the system. In this embodiment, remotely operated line A pump isolation valve 25 (normally open) is placed in line 7 and remotely operated line B pump isolation valve 24 (normally open) is placed in line 8 to close and isolate the pump when it fails.

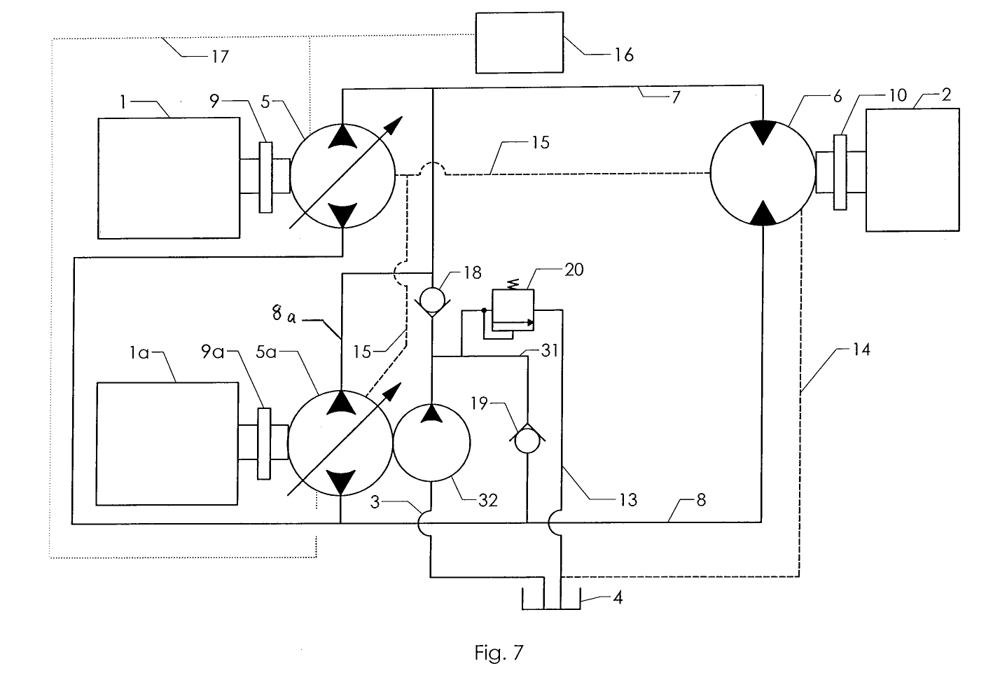

FIG. 7 illustrates a preferred closed loop embodiment very similar to that given in FIG. 1 with the exception that it utilizes a plurality of prime movers 1 and 1a with a plurality of pumps 5 and 5a with a motor 6.

Where the pump 5 is a variable displacement pump, the outlet flow of the or pump or pumps may be controlled as well as output of a variable displacement motor, if used. The external input 17 supplied to the variable displacement pump may be used to vary the flow rate to either a variable displacement motor or a fixed displacement motor. Therefore, with a the pump that displaces a flow of fluid proportional to the speed of the prime mover 1 and the speed of the variable displacement motor is controlled by varying its respective displacement. Derived embodiments utilizing hybrid combinations of those presented in FIGS. 1, 3, 5, and 7. These embodiments may include a various number of prime movers and rotating machinery. The number of prime mover and rotating machinery do not necessarily need to be equal to each other. Combinations of these embodiments may be advantageous in specific applications and therefore under the scope of the art presented here.

Referring to FIG. 2, a hydraulic variable drive (HVD) is used to variably drive some rotational machinery 2 whether it is fan, pump, compressor, conveyer, crusher or other, from mechanical power provided by a prime mover 1 of any type such as engine, electric motor, turbine or other, whether fixed or variable speed. This embodiment of the HVD is an open loop configuration and utilizes a pump 5, whether fixed or variable displacement or unidirectional or bidirectional, provides fluid to a hydraulically operated motor 6, whether unidirectional or bidirectional to operate the machinery.

The prime mover 1 drives the variable or fixed displacement pump via a mechanical connection 9. Fluid is pulled from a reservoir 4 by the pump 5 through suction line 3. The fluid is pressurized through the pump 5 and delivered to the directional control valve 22 through the pump pressure line 7. The directional control valve 22 may be used to reverse the direction of flow through the motor 6 thus reversing direction of rotation. For forward rotation, the fluid is routed to the motor 6 from the directional control valve 22 via line A 11 and returned to the directional control valve 22 via line B 12. For reverse rotation, the fluid is routed to the motor 6 from the directional control valve 22 via line B 12 and returned to the directional control valve 22 via line A 11.

The return fluid from the motor 8 is routed from the directional control valve 22 to reservoir 4 via return line 13. The outlet flow of the variable displacement pump 5 may be varied by control 16 via external input 17, resulting in a variable speed rotation of the rotating machinery 2. The external input 17 to the pump 5 is controlled by control 16. Any suitable control means may be used including hydraulic, electrical, pneumatic, or manual.

Inherent to the pump 5 and motor 6, some fluid leaks internally in the equipment and is contained in the case of the equipment. A case drain 15 feeds the internal pump leakage from the pump 5 to the motor 6. This fluid, along with internal motor leakage is drained through a case drain 14 to reservoir 4. Alternatively, the pump case drain 15 could be routed to be delivered directly to reservoir 4 without passing through the motor 6, if desired.

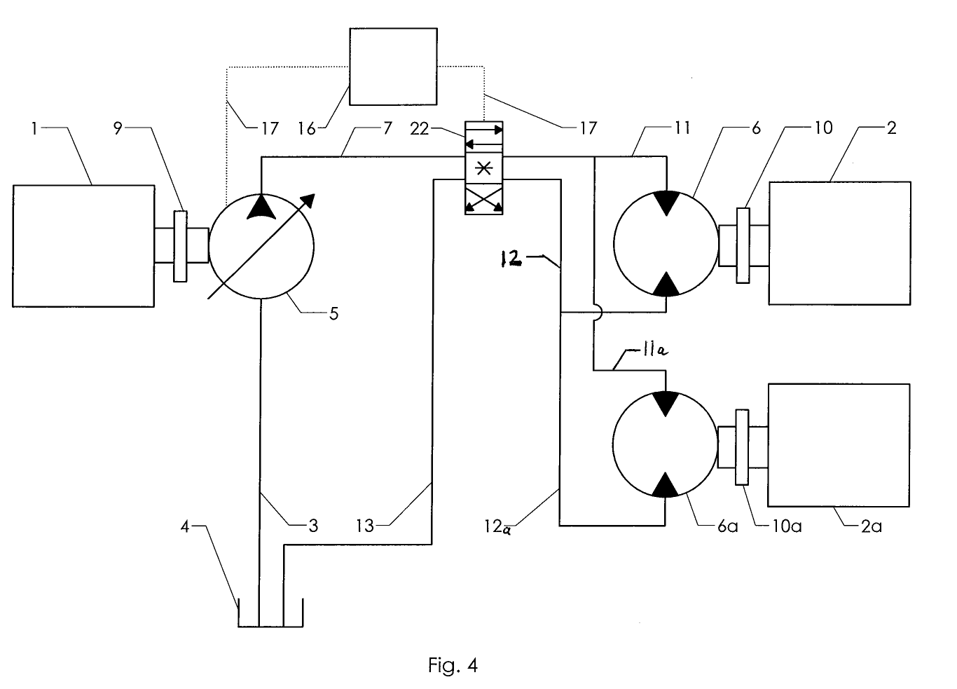

FIG. 4 illustrates a preferred open loop embodiment very similar to that given in FIG. 2 with the exception that it utilizes a pump 5 to operate a plurality of motors 6 and 6a. Therefore, the outlet flow of a variable displacement pump 5 may be controlled as well as displacement of a variable displacement motor 6 and 6a.

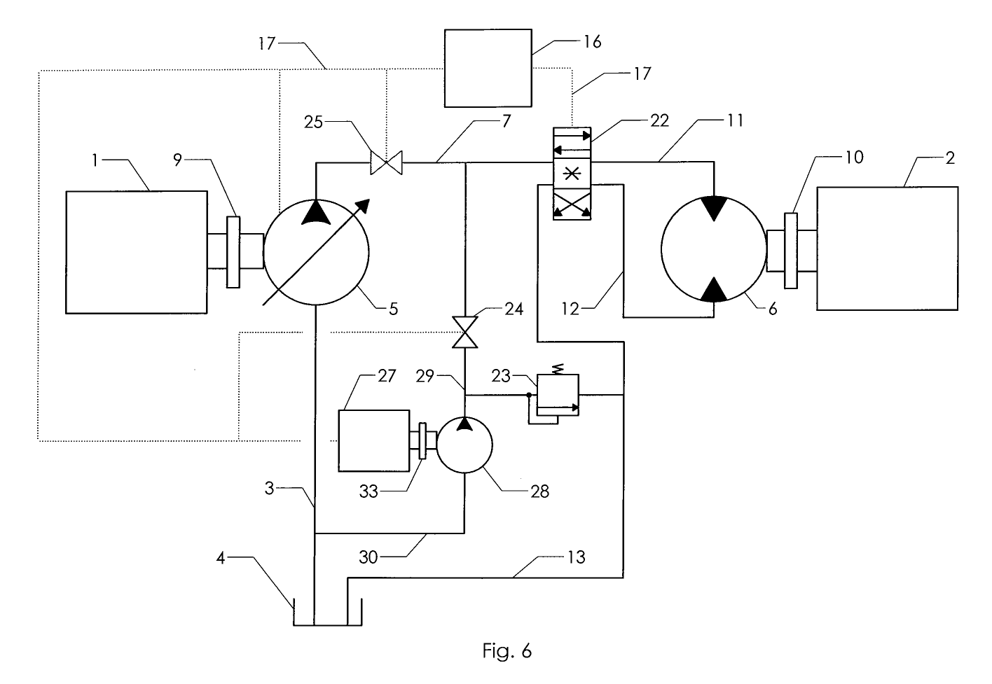

FIG. 6 illustrates a preferred open loop embodiment very similar to that given in FIG. 2 utilizing an auxiliary prime mover 27 operating an auxiliary pump 28, to avoid system damage in the event of a sudden loss of power. When auxiliary prime mover 27 is operating auxiliary pump 28, fluid flows along line 30 to line 7 through remotely operated auxiliary supply line shut off valve 24 (normally closed). This embodiment includes remotely operated return shut off valve (normally closed) for pressure release in the event of over pressurization.

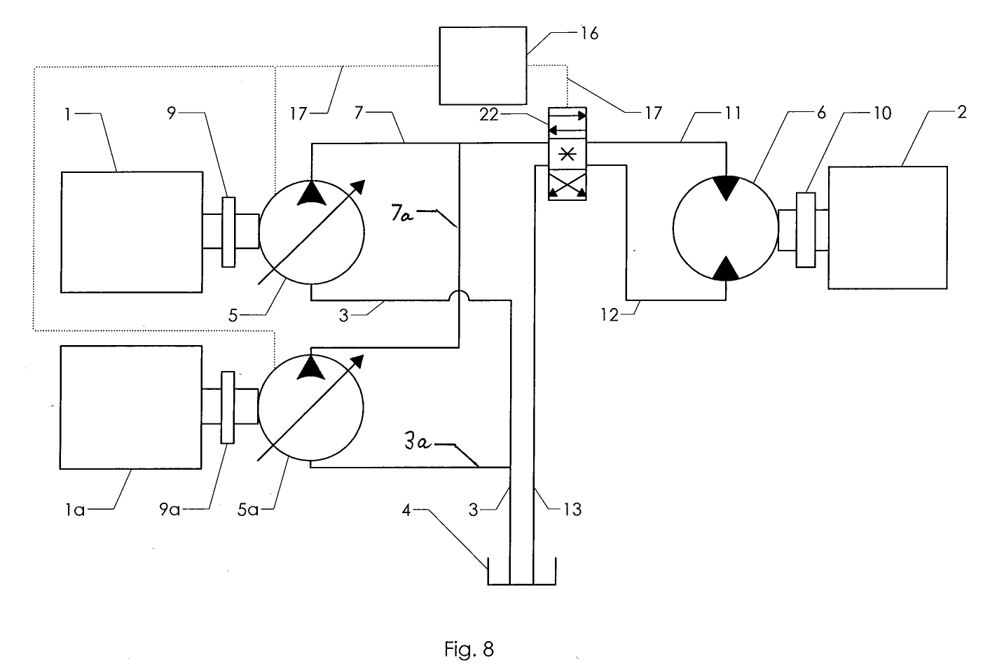

FIG. 8 illustrates a preferred open loop embodiment very similar to that given in FIG. 2 with the exception that it utilizes a plurality of prime movers 1 and 1a and a plurality of pumps 5 and 5a and a motor 6. Therefore, a variable displacement pump displaces a flow of fluid proportional to the speed of the prime mover 1 and 1a and the speed of a variable displacement motor 6 is controlled by varying its respective displacement.

For each mechanical connection 9 and 9a, 10 and 10 a and 33, any mechanical means will suffice, hydraulic pressure, gears, direct coupling, or belts as long as it permits the prime mover(s) to operate the pump(s).

Derived embodiments utilizing hybrid combinations of those presented in FIGS. 2, 4, 6, and 8 are possible. Further, these embodiments may include a various number of prime movers and rotating machinery. The number of prime movers and rotating machinery do not necessarily need to be equal to each other. Combinations of these embodiments may be advantageous in specific applications and therefore under the scope of the art presented here.

The control 16 may be any suitable means of control, including mechanical, hydraulic, electrical, pneumatic, or manual. The external input 17 operated by control 16 should vary the direction and (for variable displacement pumps) the flow rate of the pump(s). Together these elements are the means by which the control of the pump direction, flow for variable displacement pumps, and operation of the auxiliary prime mover and associated valves in the situation of a failure of the prime mover occur.

The fluid lines and drains referred to herein are the means to hydraulically connect the various elements. These may be a metal tubing, plastic tubing, flexible hose, rigid hose, or any piping that will hold hydraulic fluid. Any combination of means may be used in one application as long as they withstand the pressure of the system. The system can be high pressure or low pressure depending on the equipment being used and operated

The hydrostatic drive may be closed loop or closed circuit hydraulics, further comprising an external control oil supply which takes place via a feed pump or charge pump. The hydraulic oil flow is in a “closed loop” in that the only fluid returned to the reservoir tank is that of case drains of the pumps and motors returning the fluid lost from either internal leakage of the hydraulic pump or hydraulic motor or an over-supply of the feed pump or charge pump. The feed pump or charge pump draws the required make up fluid from the hydraulic reservoir tank.

The hydrostatic drive may be open loop or open circuit hydraulics, wherein the fluid used by the system is drawn directly from the hydraulic reservoir tank by the main pump, whether fixed or variable displacement. After flowing through the hydraulic motor, the full flow of the hydraulic pump, hydraulic motor and case drains are returned to the hydraulic reservoir tank. The main hydraulic pump must draw the full amount required by the flow demands of the system from the hydraulic reservoir tank.

A system may be comprised of a variable or fixed displacement hydraulic pump, a variable or fixed displacement hydraulic motor, or any combination of the two, dependent upon specific design demands. Consequently a plurality of pumps and/or a plurality of rotational output motors may be employed. A plurality of rotational output motors allows the simultaneous operation an a plurality of rotational equipment.

The volume displacement of the hydraulic pump (and ultimate resultant speed of the hydrostatic drive driving the driven piece of equipment or machinery) of which is adjustable by means of an adjusting device, which may be electric, electronic, hydraulic, pneumatic or mechanical. The volume displacement of the hydraulic motor (and ultimate resultant speed of the hydrostatic drive driving the driven piece of equipment or machinery) of which is adjustable by means of an adjusting device, which may be electric, electronic, hydraulic, pneumatic or mechanical. In either event, a control feedback may be included in the control for the pump which may be manual (by hand control) or automatic by feedback and/or computer, programmable logic controller (PLC) or computer numerical control (CNC).

We claim:

1. A hydrostatic drive comprising:
a prime mover; a pump; means to mechanically connect the prime mover to the pump to operate the pump; a hydraulically operated rotational motor; a first means to hydraulically connect the pump to the hydraulically operated rotational motor that will operate the motor to have a clockwise rotational output; a second means to hydraulically connect the pump to the hydraulically operated rotational motor that will operate the motor to have a counter clockwise rotational output; rotational machinery; a means to mechanically connect the hydraulically operated rotational motor to the rotational machinery that will operate the machinery.

2. A hydrostatic drive as described in claim 1 further comprising:
the pump being a variable displacement pump and the hydraulically operated rotational motor being a fixed displacement motor.

3. A hydrostatic drive as described in claim 1 further comprising:
the pump being a variable displacement pump and the hydraulically operated rotational motor being a variable displacement motor.

4. A hydrostatic drive as described in claim 1 further comprising:
the pump being a fixed displacement pump and the hydraulically operated rotational motor being a variable displacement motor.

5. A hydrostatic drive as described in claim 1 further comprising:
the pump being a fixed displacement pump and the hydraulically operated rotational motor being a fixed displacement motor.

6. A hydrostatic drive as described in claim 1 further comprising:
a reservoir tank suitable for holding hydraulic fluid; a charge pump; a means to hydraulically connect the reservoir tank to the charge pump; a first check valve; a means to hydraulically connect the charge pump to the first check valve; a means to hydraulically connect the first check valve to the hydraulic pump; a second check valve; a means to hydraulically connect the second check valve to the first check valve; a means to connect the second check valve to the hydraulic pump; an auxiliary prime mover; an auxiliary pump; means to mechanically connect the auxiliary prime mover to the auxiliary pump to operate the auxiliary pump; means to hydraulically connect the auxiliary pump to the first means to hydraulically connect the pump to the hydraulically operated rotational motor; means to hydraulically connect the reservoir tank to the second means to hydraulically connect the pump to the hydraulically operated rotational motor; a first valve located in the means to hydraulically connect the auxiliary pump to the first means to hydraulically connect the pump to the hydraulically operated rotational motor; a second valve located in the means to hydraulically connect the reservoir tank to the second means to hydraulically connect the pump to the hydraulically operated rotational motor; a third valve located in the first means to hydraulically connect the pump to the hydraulically operated rotational motor; a forth valve located in the second means to hydraulically connect the pump to the hydraulically operated rotational motor; a control to operate the auxiliary prime mover, to open the first valve, to open the second valve, to close the third valve, and to close the forth valve.

7. A hydrostatic drive as described in claim 1 further comprising:
a hydraulic control switch connected to the pump which will vary the direction and rate of flow emanating from the pump; a reservoir tank suitable to hold hydraulic fluid; a charge pump; a means to hydraulically connect the reservoir tank to the charge pump; a first check valve; a means to hydraulically connect the charge pump to the first check valve; a means to hydraulically connect the first check valve to the hydraulic pump; a second check valve; a means to hydraulically connect the second check valve to the first check valve; a means to connect the second check valve to the hydraulic pump; a relief valve hydraulically connected to the means to hydraulically connect the first check valve and to the second check valve; a means to drain the case of the pump to the reservoir tank; a means to drain the case of the rotational motor to the reservoir tank; an auxiliary prime mover; an auxiliary pump; means to mechanically connect the auxiliary prime mover to the auxiliary pump to operate the auxiliary pump; means to hydraulically connect the auxiliary pump to the first means to hydraulically connect the pump to the hydraulically operated rotational motor; means to hydraulically connect the reservoir tank to the second means to hydraulically connect the pump to the hydraulically operated rotational motor; a first valve located in the means to hydraulically connect the auxiliary pump to the first means to hydraulically connect the pump to the hydraulically operated rotational motor; a second valve located in the means to hydraulically connect the reservoir tank to the second means to hydraulically connect the pump to the hydraulically operated rotational motor; a third valve located in the first means to hydraulically connect the pump to the hydraulically operated rotational motor; a forth valve located in the second means to hydraulically connect the pump to the hydraulically operated rotational motor; a control to operate the auxiliary prime mover, to open the first valve, to open the second valve, to close the third valve, and to close the forth valve.

8. A hydrostatic drive comprising:
a prime mover; a pump; means to mechanically connect the prime mover to the pump to operate the pump; a plurality of hydraulically operated rotational motors; a first means to hydraulically connect the pump to each of the hydraulically operated rotational motors that will operate the motors in clockwise rotation; a second means to hydraulically connect the pump to the hydraulically operated rotational motors that will operate the motors in counter clockwise rotation; a plurality of rotational machinery equal to the number of rotational motors; a plurality of means to mechanically connect one of the hydraulically operated rotational motors to one of the rotational machinery such that each motor is connected a rotating machinery and each rotating machinery is connected to a motor to operate each of the rotational machinery.

9. A hydrostatic drive as described in claim 8 further comprising:
the pump being a variable displacement pump and all of the hydraulically operated rotational motors being a variable displacement motor.

10. A hydrostatic drive as described in claim 8 further comprising:
the pump being a variable displacement pump and at least one of the hydraulically operated rotational motors being a variable displacement motor and at least one of the hydraulically operated rotational motors being a fixed displacement motor.

11. A hydrostatic drive as described in claim 8 further comprising:
the pump being a variable displacement pump and all of the hydraulically operated rotational motors being a fixed displacement motor.

12. A hydrostatic drive as described in claim 8 further comprising:
the pump being a fixed displacement pump and all of the hydraulically operated rotational motors being a variable displacement motor.

13. A hydrostatic drive as described in claim 8 further comprising:
the pump being a fixed displacement pump and at least one of the hydraulically operated rotational motors being a variable displacement motor and at least one of the hydraulically operated rotational motors being a fixed displacement motor.

14. A hydrostatic drive as described in claim 8 further comprising:
the pump being a fixed displacement pump and the hydraulically operated rotational motors all being a fixed displacement motors.

15. A hydraulic drive as described in claim 8 further comprising:
a hydraulic control connected to the pump which will vary the direction and flow rate of the flow emanating from the pump; a reservoir tank suitable to hold hydraulic fluid; a charge pump; a means to hydraulically connect the reservoir tank to the charge pump; a first check valve; a means to hydraulically connect the charge pump to the first check valve; a means to hydraulically connect the first check valve to the hydraulic pump; a second check valve; a means to hydraulically connect the second check valve to the first check valve; a means to connect the second check valve to the hydraulic pump; a relief valve hydraulically connected to the means to hydraulically connect the first check valve and to the second check valve; a means to drain the case of the pump to the reservoir tank; a means to drain the case of the rotational motor to the reservoir tank; an auxiliary prime mover; an auxiliary pump; means to mechanically connect the auxiliary prime mover to the auxiliary pump to operate the auxiliary pump; means to hydraulically connect the auxiliary pump to the first means to hydraulically connect the pump to the hydraulically operated rotational motor; means to hydraulically connect the reservoir tank to the second means to hydraulically connect the pump to the hydraulically operated rotational motor; a first valve located in the means to hydraulically connect the auxiliary pump to the first means to hydraulically connect the pump to the hydraulically operated rotational motor; a second valve located in the means to hydraulically connect the reservoir tank to the second means to hydraulically connect the pump to the hydraulically operated rotational motor; a third valve located in the first means to hydraulically connect the pump to the hydraulically operated rotational motor; a forth valve located in the second means to hydraulically connect the pump to the hydraulically operated rotational motor; a control to operate the auxiliary prime mover, to open the first valve, to open the second valve, to close the third valve, and to close the forth valve.

16. A hydrostatic drive comprising:
a plurality of prime movers; a plurality of pumps equal to the number of prime movers; a plurality of means to mechanically connect a prime mover to one of the pumps to operate the pump such that each pump is connected to a prime mover and each prime mover is connected to a pump; a hydraulically operated rotational motor; a means to hydraulically connect each of the pumps to the hydraulically operated rotational motor that will operate the motor in clockwise rotation; a second means to hydraulically connect the pump to the hydraulically operated rotational motors that will operate the motor in counter clockwise rotation; rotational machinery; a means to mechanically connect the hydraulically operated rotational motor to the rotational machinery.

17. A hydrostatic drive as described in claim 16 further comprising:
a at least one of the pumps being a variable displacement pump and the hydraulically operated rotational motor being a variable displacement motor.

18. A hydrostatic drive as described in claim 16 further comprising:
at least one of the pumps being a fixed displacement pump; and the hydraulically operated rotational motor being a variable displacement motor.

19. A hydrostatic drive as described in claim 16 further comprising:
at least one of the pumps being fixed displacement pump and the hydraulically operated rotational motor being a fixed displacement motor.

20. A hydrostatic drive as described in claim 16 further comprising:
at least one of the pumps being a fixed displacement pump and the hydraulically operated rotational motor being a fixed displacement motor.

21. A hydrostatic drive as described in claim 16 further comprising:
a control connected to each of the pumps which will vary the direction and flow rate of the flow emanating from each of the pumps; a reservoir tank suitable to hold hydraulic fluid; a charge pump; a means to hydraulically connect the reservoir tank to the charge pump; a first check valve; a means to hydraulically connect the charge pump to the first check valve; a means to hydraulically connect the first check valve to the hydraulic pump; a second check valve; a means to hydraulically connect the second check valve to the first check valve; a means to connect the second check valve to the hydraulic pump; a relief valve hydraulically connected to the means to hydraulically connect the first check valve and to the second check valve; a means to drain the case of the pump to the reservoir tank; a means to drain the case of the rotational motor to the reservoir tank; an auxiliary prime mover; an auxiliary pump; means to mechanically connect the auxiliary prime mover to the auxiliary pump to operate the auxiliary pump; means to hydraulically connect the auxiliary pump to the first means to hydraulically connect the pump to the hydraulically operated rotational motor; means to hydraulically connect the reservoir tank to the second means to hydraulically connect the pump to the hydraulically operated rotational motor; a first valve located in the means to hydraulically connect the auxiliary pump to the first means to hydraulically connect the pump to the hydraulically operated rotational motor; a second valve located in the means to hydraulically connect the reservoir tank to the second means to hydraulically connect the pump to the hydraulically operated rotational motor; a third valve located in the first means to hydraulically connect the pump to the hydraulically operated rotational motor; a forth valve located in the second means to hydraulically connect the pump to the hydraulically operated rotational motor; a control to operate the auxiliary prime mover, to open the first valve, to open the second valve, to close the third valve, and to close the forth valve.

22. A hydrostatic drive comprising:
a plurality of prime movers; a plurality of pumps equal to the number of prime movers; a plurality of means to mechanically connect a prime mover to one of the pumps to operate the pump such that each pump is connected to a prime mover and each prime mover is connected to a pump; a plurality of hydraulically operated rotational motors; a means to hydraulically connect each of the pumps to each of the rotational motors that will operate the rotational motor in clockwise rotation; a second means to hydraulically connect each of the pumps to each of the rotational motors that will operate the rotational motors in counter clockwise rotation; a plurality of rotational machinery; a plurality of means to mechanically connect one of the rotational motors to one of the rotational machinery such that each motor is connected to a rotational machinery and each rotational machinery is connected to a rotational motor.

23. A hydrostatic drive as described in claim 22 further comprising:
at least one of the pumps being a variable displacement pump and at least one of the rotational motors being a variable displacement rotational motor.

24. A hydrostatic drive as described in claim 22 further comprising:
at least one of the pumps being a variable displacement and at least one of the rotational motors being a fixed displacement rotational motor.

25. A hydrostatic drive as described in claim 22 further comprising:
at least one the pumps being a fixed displacement pumps and at least one of the rotational motors being a fixed displacement rotational motor.

26. A hydrostatic drive as described in claim 22 further comprising:
at least one the pumps being a fixed displacement pumps and at least one of the rotational motors being a variable displacement rotational motor.

27. A hydrostatic drive as described in claim 22 further comprising:
a control connected to each of the pumps which will vary the direction and flow rate of the flow emanating from each pump; a reservoir tank suitable to hold hydraulic fluid; a charge pump; a means to hydraulically connect the reservoir tank to the charge pump; a first check valve; a means to hydraulically connect the charge pump to the first check valve; a means to hydraulically connect the first check valve to the hydraulic pump; a second check valve; a means to hydraulically connect the second check valve to the first check valve; a means to connect the second check valve to the hydraulic pump; a relief valve hydraulically connected to the means to hydraulically connect the first check valve and to the second check valve; a means to drain the case of the pump to the reservoir tank; a means to drain the case of the rotational motor to the reservoir tank; an auxiliary prime mover; an auxiliary pump; means to mechanically connect the auxiliary prime mover to the auxiliary pump to operate the auxiliary pump; means to hydraulically connect the auxiliary pump to the first means to hydraulically connect the pump to the hydraulically operated rotational motor; means to hydraulically connect the reservoir tank to the second means to hydraulically connect the pump to the hydraulically operated rotational motor; a first valve located in the means to hydraulically connect the auxiliary pump to the first means to hydraulically connect the pump to the hydraulically operated rotational motor; a second valve located in the means to hydraulically connect the reservoir tank to the second means to hydraulically connect the pump to the hydraulically operated rotational motor; a third valve located in the first means to hydraulically connect the pump to the hydraulically operated rotational motor; a forth valve located in the second means to hydraulically connect the pump to the hydraulically operated rotational motor; a control to operate the auxiliary prime mover, to open the first valve, to open the second valve, to close the third valve, and to close the forth valve.

28. A hydrostatic drive comprising:
a prime mover; a pump; a means to mechanically connect the prime mover to the pump to operate the pump; a rotational motor; a directional control valve; a means to hydraulically connect the pump to the directional control valve; a means to hydraulically connect the directional control valve to the rotational motor that will operate the rotational motor in clockwise rotation; a second means to hydraulically connect the rotational motor to the directional control valve that will operate the motor in counterclockwise rotation; rotational machinery; a means to mechanically connect the rotational motor to the rotational machinery to operate the machinery.

29. A hydrostatic drive as described in claim 28 further comprising:
the pump being a variable displacement pump and the rotational motor being a fixed displacement rotational motor.

30. A hydrostatic drive as described in claim 28 further comprising:
the pump being a fixed displacement pump and the rotational motor being a variable displacement rotational motor.

31. A hydrostatic drive as described in claim 28 further comprising:
the pump being a variable displacement pump and the rotational motor being a variable displacement rotational motor.

32. A hydrostatic drive as described in claim 28 further comprising:
a control means connected to the pump to vary the direction and rate of flow emanating from the pump an auxiliary prime mover; an auxiliary pump; means to mechanically connect the auxiliary prime mover to the auxiliary pump to operate the auxiliary pump; means to hydraulically connect the auxiliary pump to the means to hydraulically connect the pump to the directional control valve; a first valve located in the means to hydraulically connect the auxiliary pump to the means to hydraulically connect the pump to the directional control valve; a second valve located in the means to hydraulically connect the pump to the directional control valve; a control to operate the auxiliary prime mover, to open the first valve, to close the second valve.

33. A hydrostatic drive as described in claim 28 further comprising:
a reservoir tank suitable to hold hydraulic fluid; a means to hydraulically connect the reservoir tank to the pumps; a means to hydraulically connect the reservoir tank to the directional control valve; a control means connected to the pump to vary the direction and rate of flow emanating from the pump an auxiliary prime mover; an auxiliary pump; means to mechanically connect the auxiliary prime mover to the auxiliary pump to operate the auxiliary pump; means to hydraulically connect the auxiliary pump to the means to hydraulically connect the pump to the directional control valve; a first valve located in the means to hydraulically connect the auxiliary pump to the means to hydraulically connect the pump to the directional control valve; a second valve located in the means to hydraulically connect the pump to the directional control valve; a control to operate the auxiliary prime mover, to open the first valve, to close the second valve.

34. A hydrostatic drive comprising:
a plurality of prime movers; a plurality of pumps; a plurality of means to mechanically connect a prime mover to a pump to operate the pump such that each prime mover is connected to a pump and each pump is connected to a prime mover; a hydraulically operated rotational motor; rotational machinery; a means to mechanically connect the rotational motor to the rotational machinery; a directional control valve; a means to hydraulically connect the pumps to the directional control valve; a means to hydraulically connect the directional control valve to the rotational motor with the flow used to operate the rotational motor in clockwise rotation; a second means to hydraulically connect each of the rotational motors to the directional control valve to operate the rotational motor in counterclockwise rotation.

35. A hydrostatic drive as described in claim 34 further comprising:
at least one of the pumps being a variable displacement pump; and the rotational motor being a variable displacement rotational motor.

36. A hydrostatic drive as described in claim 34 further comprising:
at least one of the pumps being a fixed displacement pump and the rotational motor being a variable displacement rotational motor.

37. A hydrostatic drive as described in claim 34 further comprising:
at least one of the pumps being a fixed displacement pump; and the rotational motor being a fixed displacement rotational motor.

38. A hydrostatic drive as described in claim 34 further comprising:
at least one of the pumps being a variable displacement pump and the rotational motor being a fixed displacement rotational motor.

39. A hydrostatic drive as described in claim 34 further comprising:
a reservoir tank suitable to hold hydraulic fluid; a means to hydraulically connect the reservoir tank to the pumps; a means to hydraulically connect the reservoir tank to the directional control valve; a control means connected to the pump to vary the direction and rate of flow emanating from the pump an auxiliary prime mover; an auxiliary pump; means to mechanically connect the auxiliary prime mover to the auxiliary pump to operate the auxiliary pump; means to hydraulically connect the auxiliary pump to the means to hydraulically connect the pump to the directional control valve; a first valve located in the means to hydraulically connect the auxiliary pump to the means to hydraulically connect the pump to the directional control valve; a second valve located in the means to hydraulically connect the pump to the directional control valve; a control to operate the auxiliary prime mover, to open the first valve, to close the second valve.

40. A hydrostatic drive comprising:
a prime mover; a pump; a means to mechanically connect the prime mover to the pump to operate the pump; a plurality of hydraulically operated rotational motors; a directional control valve; a means to hydraulically connect the pump to the directional control valve; a means to hydraulically connect the directional control valve to each of the rotational motors with the flow used to operate the rotational motor in rotational direction; a second means to hydraulically connect each of the rotational motors to the directional control valve to operate each of the rotational motors in a the rotational direction opposite from the first such means; a plurality of rotational machinery equal in numbers to the number of rotational motors; a plurality of means to mechanically connect a rotational motor to a rotational machinery such that each rotational motor is connected to a rotational machinery and each rotational machinery is connected to a rotational motor.

41. A hydrostatic drive as described in claim 40 further comprising:
the pump being a variable displacement pump and at least one of the rotational motors being a variable displacement rotational motor.

42. A hydrostatic drive as described in claim 40 further comprising:
the pump being a variable displacement pump and at least one of the rotational motors being a fixed displacement rotational motor.

43. A hydrostatic drive as described in claim 40 further comprising:
the pump being a fixed displacement pump and at least one of the rotational motors being a fixed displacement rotational motor.

44. A hydrostatic drive as described in claim 40 further comprising:
the pump being a fixed displacement pump and at least one of the rotational motors being a variable displacement rotational motor.

45. A hydraulic drive as described in claim 40 further comprising:
a reservoir tank suitable to hold hydraulic fluid; a means to hydraulically connect the reservoir tank to the pump; a means to hydraulically connect the reservoir tank to the directional control valve; a control means connected to the pump to vary the direction and rate of flow emanating from the pump an auxiliary prime mover; an auxiliary pump; means to mechanically connect the auxiliary prime mover to the auxiliary pump to operate the auxiliary pump; means to hydraulically connect the auxiliary pump to the means to hydraulically connect the pump to the directional control valve; a first valve located in the means to hydraulically connect the auxiliary pump to the means to hydraulically connect the pump to the directional control valve; a second valve located in the means to hydraulically connect the pump to the directional control valve; a control to operate the auxiliary prime mover, to open the first valve, to close the second valve.

46. A hydrostatic drive comprising:
a plurality of prime movers; a plurality of pumps equal in number to the number of prime movers; a plurality of means to mechanically connect a prime mover to a pump to operate the pump such that each pump is connected to a prime mover and each prime mover is connected to a pump; a plurality of hydraulically operated rotational motors; a directional control valve; a means to hydraulically connect each of the pumps to the directional control valve; a means to hydraulically connect the directional control valve to each of the rotational motors with the flow emanating from the directional control valve used to operate the rotational motors in a rotational direction; a second means to hydraulically connect the rotational motors to the directional control valve with the flow emanating from the directional control valve used to operate the rotational motors in the opposite rotational direction from the first such means; a plurality of rotational machinery equal in number to the number of rotational motors; a plurality of means to mechanically connect the rotational motors to the each rotational machinery such that each rotational motor is connected to a rotational machinery and each piece of rotational machinery is connected to a rotational motor.

47. A hydrostatic drive as described in claim 46 further comprising:
at last one of the pumps being a variable displacement pump and at least one of the rotational motors being a variable displacement rotational motor.

48. A hydrostatic drive as described in claim 46 further comprising:
at least one of the pumps being a fixed displacement pump and at least one of the rotational motors being a variable displacement rotational motor.

49. A hydrostatic drive as described in claim 46 further comprising:
at least one of the pumps being a fixed displacement pump and at least one of the rotational motors being a fixed displacement rotational motor.

50. A hydrostatic drive as described in claim 46 further comprising:
at least one of the pumps being a fixed displacement pump and at least one of the rotational motors being a variable displacement rotational motor.

51. A hydrostatic drive as described in claim 46 further comprising:
a reservoir tank suitable to hold hydraulic fluid; a means to hydraulically connect the reservoir tank to the pumps; a means to hydraulically connect the reservoir tank to the directional control valve; a control means connected to the pumps to vary the direction and rate of flow emanating from the pumps; an auxiliary prime mover; an auxiliary pump; means to mechanically connect the auxiliary prime mover to the auxiliary pump to operate the auxiliary pump; means to hydraulically connect the auxiliary pump to the means to hydraulically connect the pump to the directional control valve; a first valve located in the means to hydraulically connect the auxiliary pump to the means to hydraulically connect the pump to the directional control valve; a second valve located in the means to hydraulically connect the pump to the directional control valve; a control to operate the auxiliary prime mover, to open the first valve, to close the second valve.
